(19) United States
(12) Patent Application Publication
(10) Pub. No.: US 2013/0236863 A1
(43) Pub. Date: Sep. 12, 2013

(54) SYSTEM AND METHOD FOR PROVIDING TELEPHONY BASED MATHEMATIC TESTING

(71) Applicant: Amir Kiai, Irvine, CA (US)

(72) Inventor: Amir Kiai, Irvine, CA (US)

(21) Appl. No.: 13/786,396

(22) Filed: Mar. 5, 2013

Related U.S. Application Data
(60) Provisional application No. 61/607,317, filed on Mar. 6, 2012.

(51) Int. Cl. G09B 7/02

(52) U.S. Cl. CPC G09B 7/02
USPC 434/188

(57) ABSTRACT

The present invention generally relates to testing methods. Specifically, the present invention relates to a computer implemented system and method for providing testing in one or more academic subjects over one or more telephone or audio/voice communication means.

### CROSS-REFERENCE TO RELATED APPLICATIONS

This application claims the benefit of the following provisional applications, each of which is hereby incorporated by reference in its entirety: U.S. Pat. App. No. 61/607,317 filed on Mar. 6, 2012 and entitled “SYSTEM AND METHOD FOR PROVIDING TELEPHONY BASED MATHEMATIC TESTING.”

### FIELD OF THE INVENTION

The present invention generally relates to testing methods. Specifically, the present invention relates to a computer implemented system and method for providing testing in one or more academic subjects over one or more telephone or audio/voice communication means.

### BACKGROUND

While numerous systems today provide computerized academic testing, these systems all require a user to have access to a computing device. Further, many computerized academic testing systems require access to the Internet or other wide area communications network. While computing devices have become ubiquitous in more affluent societies and neighborhoods, not every family, community or individual is blessed with access to these same levels of modern technology.

While not all individuals have access to computing devices, in general, especially in the United States, access to telephony systems (e.g., public or private phone lines) are generally available to all. In fact, the Unites States even has programs whereby lower income and impoverished people may receive free or supplemented telephony systems for emergencies and toll-free calling.

Whereas easy access to telephony systems may be available, there are currently no equivalents to the automated computerized academic testing systems provided to those with access to the Internet and personal computing devices. As such, access to these testing systems is limited to those with computing devices and access to the Internet, as opposed to those with only a telephone based communication means.

Therefore, there is need in the art for systems and methods for providing testing in one or more academic subjects over one or more telephone or audio/voice communication means. These and other features and advantages of the present invention will be explained and will become obvious to one skilled in the art through the summary of the invention that follows.

### SUMMARY OF THE INVENTION

Accordingly, it is an aspect of the present invention to provide systems and methods for providing testing in one or more academic subjects over one or more telephone or audio/voice communication means.

According to an embodiment of the present invention, a method for providing telephony based mathematic testing includes the steps of: receiving a communication from a user over a telephony means; verifying the user via an audio based authentication means; receiving a selection of academic subject to be tested from the user; providing to the user one or more questions in an audio format, wherein the one or more questions are selected from the academic subject; receiving an answer from the user over the telephony means; checking the answer for correctness; and providing a response to the user based on the answer.

According to an embodiment of the present invention, each question of the one or more questions is comprised of a preamble, a first number, an operator and a second number [0010]According to an embodiment of the present invention, the preamble and the operator are retrieved from a database and the first number and the second number are generated by a random number generator.

According to an embodiment of the present invention, the audio for the preamble, the operator, the first number and the second number are generated by a text-to-speech generator.

According to an embodiment of the present invention, the answer is retrieved from a database associated with the one or more questions.

According to an embodiment of the present invention, the answer is generated automatically by a computing device applying the operator to the first number and the second number.

According to an embodiment of the present invention, the method includes the steps of: providing an audible option for altering an amount of questions comprising the one or more questions; receiving an audible response to the audible option; and altering the amount of questions based on the audible response.

According to an embodiment of the present invention, each question of the one or more questions is comprised of a preamble, one or more numbers and one or more operators.

According to an embodiment of the present invention, a system for providing telephony based mathematic testing includes: a telephony based interactive voice response module comprising computer-executable code stored in non-volatile memory; a processor; and a telephony means, wherein the interactive voice response module, the processor, and the telephony means are operably connected and are configured to: receive a communication from a user over a telephony means; verifying the user via an audio based authentication means; receiving a selection of academic subject to be tested from the user; providing to the user one or more questions in an audio format, wherein the one or more questions are selected from the academic subject; receiving an answer from the user over the telephony means; checking the answer for correctness; and providing a response to the user based on the answer.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 illustrates an exemplary method, in accordance with an embodiment of the present invention;

FIG. 4 illustrates a process flow for an IVR Level 1 Flow, in accordance with an embodiment of the present invention; and

FIG. 5 illustrates a process flow for an IVR Level 4-6 Flow, in accordance with an embodiment of the present invention.

### DETAILED SPECIFICATION

The present invention generally relates to academic subject testing methods. Specifically, the present invention relates to a computer implemented system and method for providing academic subject testing over one or more telephone or audio/voice communication means.

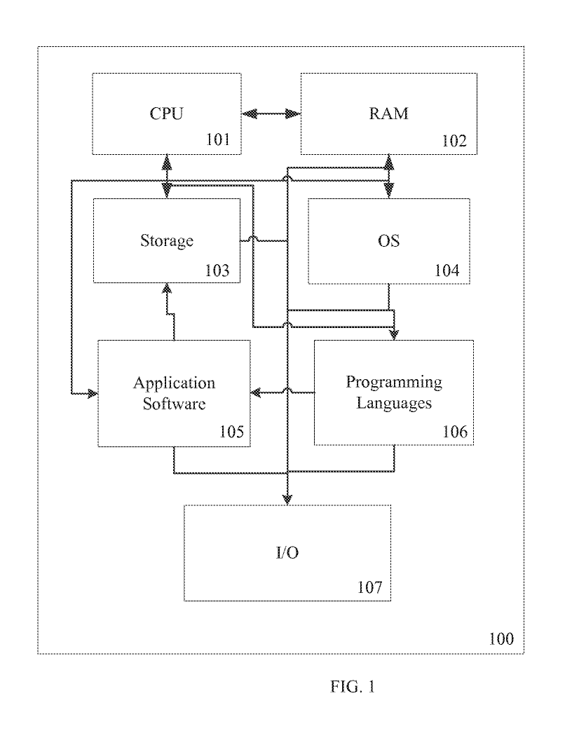

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, one or more programming languages 106 and one or more input/output devices/means 107. Examples of computing devices usable with embodiments of the present invention include, but are not limited to, personal computers, smart phones, laptops, mobile computing devices, tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention a user may be able to compose data offline that will be consumed by the system when the user is later connected to a network.

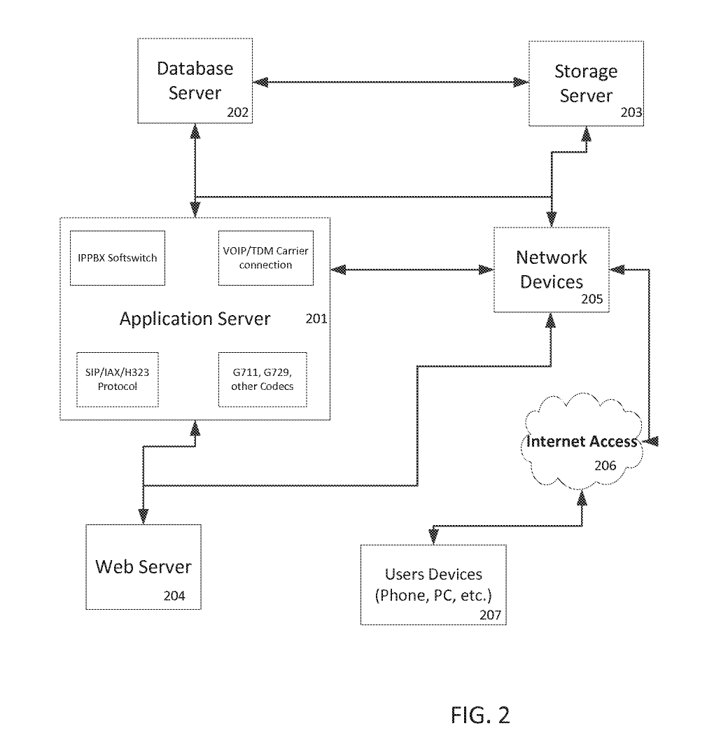

Referring to FIG. 2, a schematic overview of a system in accordance with an embodiment of the present invention is shown. The system is comprised of one or more application servers 201 for electronically processing and storing information used by the system. Applications in the application server 201 may retrieve and manipulate information in local storage devices or with one or more of a database server 202, a storage server 203, and a web server 204 and exchange information through one or more network devices 205 potentially connected to one or more LANs or WANs 206 (e.g., the Internet). In certain embodiments of the present invention, the application server 201 is configured to receive communications from one or more telephony systems via one or more communications means (e.g., IPPBX, VOIP/TDM, SIP/IAX/H323 protocol, G711/G729 Codec). One of ordinary skill in the art would appreciate that there are numerous communications means that could be utilized with embodiments of the present invention, and embodiments of the present invention are contemplated for use with any communications means. Applications in application server 201 may also be used to manipulate information stored remotely and process and analyze data stored remotely across a WAN 206 (e.g., the Internet). The various servers (i.e., application server 201, database server 202, storage server 203 and web server 204) may be operatively connected via one or more connection means (e.g., network devices 205, cable connections, wireless connections). In other embodiments the various servers may be situated on a single multi-purpose machine (e.g., enterprise server) with each component being communicatively connected within the single multi-purpose machine. One of ordinary skill in the art would appreciate that there are numerous manners and methods for connecting the various components of the present invention, and embodiments of the present invention are contemplated for use with any manner or method of connecting the various components.

According to an exemplary embodiment, as shown in FIG. 2, exchange of information through the WAN 206 or other network may occur through one or more high speed connections. In some cases, high speed connections may be over-the-air (OTA), passed through networked systems, directly connected to one or more WANs 206 or directed through one or more network devices 205. Network devices 205 are completely optional and other embodiments in accordance with the present invention may or may not utilize one or more network devices 205.One of ordinary skill in the art would appreciate that there are numerous ways application server 201 may connect to WAN 206 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to application server 201 via WAN 206 or other networks and network devices 205 in numerous ways. For instance, a user may connect to the system through a user device 207 directly connected to the WAN 206, ii) through a computing device 207, through a network device (not shown), or iii) through a computing device 207connected to a wireless access point (not shown). One of ordinary skill in the art would appreciate that there are numerous ways that a component may connect to application server 201 via WAN 206 or other network, and embodiments of the present invention are contemplated for use with any method for connecting to application server 201 via WAN 206 or other network. Furthermore, application server 201 could be comprised of a personal computing device, such as a smartphone, acting as a host for other computing devices to connect to.

In a preferred embodiment, for the purpose of providing math tests to users, a user may be able to connect to the application server 201 via a user device 207 comprising a telephony device. Telephony devices include, but are not limited to, landline telephones, cellular telephones, smartphones, and voice over IP (VOIP) means (e.g., VOIP phones, VOIP via a computing device). One of ordinary skill in the art would appreciate that there are numerous types of telephony devices that may be utilized with embodiments of the present invention, and embodiments of the present invention are contemplated for use with any type of telephony device. Connections to the application server 201 by a telephony device may be via a wireless connection means (e.g., CDMA, GMS, 3G, 4G), via a wired connection means (e.g., phone line, Ethernet) or any combination thereof

According to an embodiment of the present invention, the system and methods described herein provide users the ability to train and hone their skills and levels in one or more academic subjects. Preferred embodiments of the present invention are directed to help students of the primary and secondary level of schooling (i.e., grades K-12). However, one of ordinary skill in the art would appreciate that embodiments of the present invention could be utilized to help students or users of any grade level or education level.

According to an embodiment of the present invention, the system and methods described herein are configured to increase the effectiveness, efficiency, quickness with which users improve their skills and levels in various academic subjects. Embodiments of the present invention further provide parents a hands-off approach to assist their kid's frequent practices and quizzes. While the present application will focus on embodiments of the present invention directed to providing students/users with testing methods associated with mathematics, one of ordinary skill in the art would appreciate that embodiments of the present invention could be utilized for increasing the knowledge and abilities of students/users in any number of academic subjects, and embodiments of the present invention are contemplated for use with any academic subject.

According to an embodiment of the present invention, the system and methods described herein accomplish this by providing the users the ability to contact a phone service via a telephony device, utilizing a phone number. The phone number may be toll-free or not and may or may not be based on a country the user lives in or is associated with. In alternate embodiments, students may be able to contact a phone service without utilizing a number (e.g., via a network or other means not contacted via dialing a number). In a preferred embodiment, users will call a number, reach the phone service and hear one or more math questions which may be preselected based on criteria associated with the user. Criteria may include, but are not limited to, age of the user, grade level of the user, testing level of the user, selections made by the user or any combination thereof. One of ordinary skill in the art would appreciate that there are numerous criteria that may be utilized with embodiments of the present invention, and embodiments of the present invention are contemplated for use with any criteria.

According to an embodiment of the present invention, the systems and methods described herein reduce the time, cost and headaches associated with the provision of math quizzes to users and also provide users or other individuals (e.g., parents, guardians, teachers, administrators) to monitor the performance of a user. In a preferred embodiment of the present invention, a telephony based Interactive Voice Response (IVR) system is utilized to assist users with performing one or more math tests. Advantageously, the system provides a low cost method for taking tests. As opposed to internet based methods or methods involving teachers or tutors, embodiments of the present invention can be conducted over a standard telephone, making embodiments accessible by users in almost any location as even those in the poorest of areas typically have access to a phone, whether public or private. Further, since the system is provided over a phone via an access number, the user only has access to content provided by the system. In this manner, individuals associated with the user (e.g., parents, guardians, teachers, administrators)will not have to monitor the users to make sure the user is not being introduced to otherwise inappropriate content (e.g., adult media, internet predators).

According to an embodiment of the present invention, the system is implemented through the use of various IVR Levels which represent options selectable through an interactive menu. In a preferred embodiment, the IVR levels are caused to be transitioned between when certain responses are received from a user. Responses may be made via voice commands, alphanumeric commands entered into a keypad of a telephony device or entered via any other appropriate response means (e.g., touch screen, keyboard, pointer device). While progressing through the various IVR levels, the method shall be described herein in terms of steps, with transitions between the various IVR levels typically being referred to as a Step, or, in series, Steps. Step 1 Authenticates the user registration status based on a user ID assigned to the user earlier during a registration process. Once Step 1 is selected and confirmed by pressing a specific key on the phone keypad, speech to text technology or other appropriate means, the Students will then be directed to IVR Level 2 (Step 2).

Optionally, the system may be configured to utilize additional Steps prior to Step 302 for selection of the user's native speaking language and the academic subject the User wishes to be quizzed/tested on. Academic subjects include, but are not limited to, Physics, Chemistry, History and Biology. One of ordinary skill in the art would appreciate that there are numerous academic subjects that could be utilized with embodiments of the present invention, and embodiments of the present invention are contemplated for use with any academic subject. The current Step 2 described herein is called “Math Operations. “While Math itself is an academic subject, according to an embodiment of the present invention, in Step 2, users will hear choices of math operations to select from such as addition, subtraction, multiplication, division, algebra, trigonometry and calculus. One of ordinary skill in the art would appreciate that there are numerous types of math operations that could be utilized with embodiments of the present invention, and embodiments of the present invention are contemplated for use with any type of math operation.

In a preferred embodiment, the user must select one or more math operations available to them and confirm them via pressing the key, speech to text technology or other appropriate means. The system may also be configured to allow users to select a difficultly to be associated with the type of math operation selected(Step 3). Difficulty can be selected based on one or more criteria (e.g., user grade level, relative difficulty level, user age, number of digits or operations). One of ordinary skill in the art would appreciate that there are numerous methods for selecting a difficulty, and embodiments of the present invention are contemplated for use with any method for selecting a difficulty. In a preferred embodiment, IVR is utilized in addition to user criteria for selecting difficulty level in addition to the User criteria determining the difficult level. Once the difficulty level is determined, the system then proceeds to Step 4.

According to an embodiment of the present invention, in Step 4, users will hear math questions based on the difficulty level per their selected math operation difficulty level from Step 302 and confirm their answer selection via entry on the phone keypad, via speech to text technology or other appropriate means. Answers may be entered manually based on alphanumeric answers, selected from multiple choices or any combination thereof. One of ordinary skill in the art would appreciate that there are numerous ways to provide answers via a keypad, via speech to text technology or other appropriate means.

In Step 304, random questions and their respective answers will be retrieved from the data stores associated with the system. Data stores may be one or more of a database server, a storage medium, a clustered network or other means for storing data. One of ordinary skill in the art would appreciate that there are numerous types of data stores that may be utilized with embodiments of the present invention, and embodiments of the present invention are contemplated for use with any type of data stores. In a preferred embodiment, the data stores are operably connected to one or more application servers, configured to perform processing of the data. According to an embodiment of the present invention, the questions and respective answers are based on the criteria as identified above. The questions, answers and results may be provided to the user via text to speech, IVR, or other appropriate means (e.g., presented on a display of the telephony device utilized by the user). In another embodiment, the answers, results and other audible responses to the user are provided by playing one or more pre-recorded sounds in order to create the audible response. Each number may either be recorded separately where necessary (e.g., 1, 2, 3, 11, 12, 13) or be a combination of two or more pre-recorded sounds (e.g., 22—twenty and two). Recorded sounds are not limited to numbers, but may also include words, expressions, operators or other sounds required to implement the system. Recorded sounds may be stored and retrieved as needed by the system, such as in a database, data store or other repository.

According to an embodiment of the present invention, at an optional Step 4a, the system may provide an additional IVR level to provide the user with the ability to add more questions to the current quiz/test. This IVR level may be reached, for instance, by pressing a specific key or saying a phrase (e.g., “add more questions”) at any point during Step 4. In this manner, a user who wishes to continue to practice a subject may add additional questions at their convenience.

According to an embodiment of the present invention, the system provides a novel method for announcing the numbers in an answer, question or other routine. In this method, the system is first configured to analyze the entire number for the number of digits(this step may be replicated for up to 5 digits). If the number of digits is equal to three, the system is configured to pronounce the 100's of the digit from (1 to 9)+hundred. If the second number is equal to zero, the system is configured to not pronounce the second number and the system then analyzes the number on the far right and pronounces the correct number between 1 and 9. However, if the second number is equal to one, then the system is configured to analyze the far right number and pronounce the correct number between 10 and 19. Provided further, if the second number equals or is higher than two, then the system is configured to pronounce the 10's of the digit from 20 through 90 in 10 digit increments. If the far right number is equal to zero, then the system is configured to not pronounce the far right number. Otherwise, the system is configured to pronounce the number on the far right from 1 to 9.

According to an embodiment of the present invention, continuing from the novel method above, if the number of digits in a response is equal to two, then the system is configured to look first at the far left number. If the far left number is equal to one, then the system will analyze the far right number and pronounce the correct number between 10 and 19. If the far left number is equal or higher than 2, then the system is configured to analyze the far left number and pronounce the correct number between 20 and 90 in 10 digit increments. If the far right number is equal to zero, then the system is configured not pronounce the far right number. If the far right number is greater than zero, the system is configured to pronounce the correct number from 1 to 9.

According to an embodiment of the present invention, the system may be configured to repeat the steps outlined above for responses with a number of digits greater than 3. One of ordinary skill in the art would appreciate that the above outlined method could be utilized with response of any number of digits.

### Exemplary Embodiment

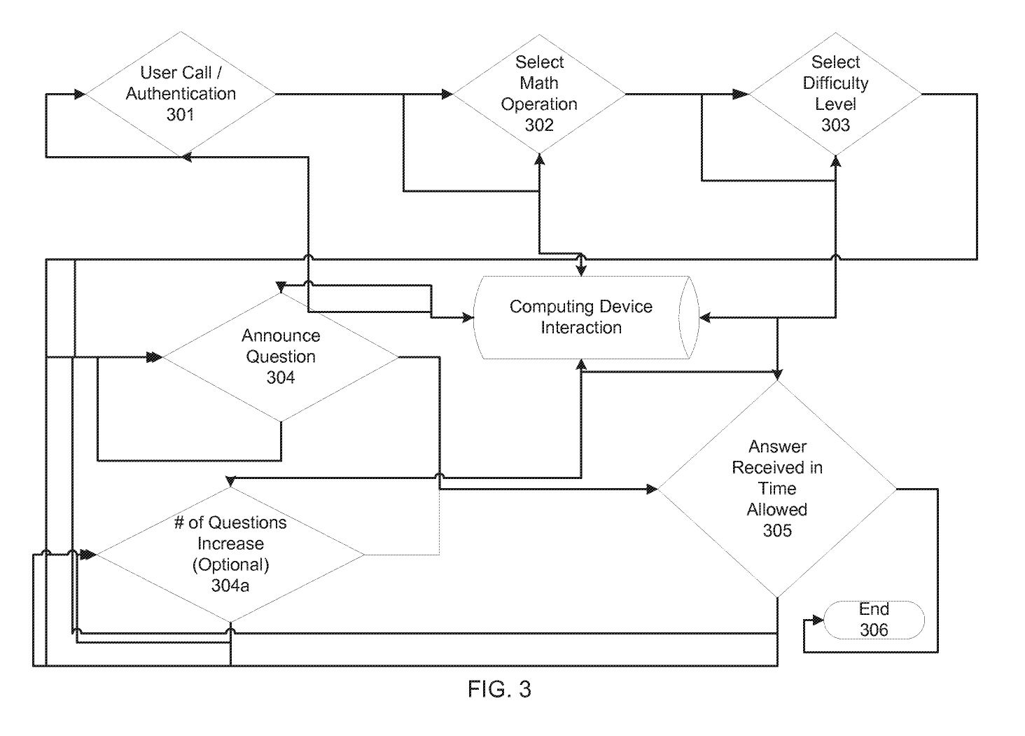

Turning now to FIG. 3, an exemplary method, in accordance with an embodiment of the present invention is shown. In Step 301, a user will call into a national phone number, be presented with a welcome greeting as well as IVR prompting for Students to enter/say their “n” digits User ID. The user must confirm his/her entry by entering/saying the confirmation such as pressing the pound key or saying “next.” One of ordinary skill in the art would appreciate that there are numerous methods for confirming an entry, and embodiments of the present invention are contemplated for use with any method for confirming an entry. If the entry received is not valid, the system repeats Step 301. In certain embodiments, if the user fails to enter a valid response within a set number of attempts, they may be disconnected from the service.

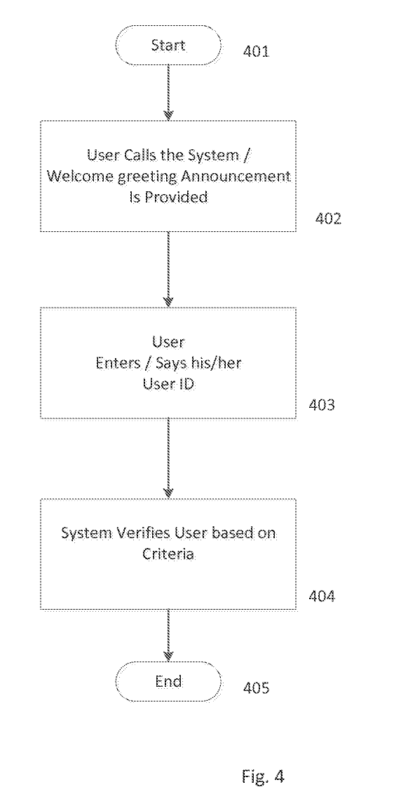

Turning now to FIG. 4, an exemplary embodiment of an authentication process of the Step 301 is shown. The process starts 401 upon the receipt of a call at the system. The system receives the call and provides a welcome greeting to the user and instructs the user to enter his/her User ID 402. In a preferred embodiment, the user then enters his/her User ID 403 by entering an alphanumeric answer on a keypad of their telephony device or by saying the User ID, which will be interpreted by a voice-to-text/data method as described above. The system then verifies the user based on the response 404. Upon successful verification, Step 1 ends 405. If an invalid response is received, the process may be repeated as described above. The aforementioned authentication means is representative of an ideal authentication means for verifying the user's identity. One of ordinary skill in the art would appreciate that there are numerous types of authentication means that could be utilized with embodiments of the present invention, and embodiments of the present invention are contemplated for use with any appropriate authentication means.

Upon the confirmation, the user is directed to the next IVR Level 2 (Step 302) to select their desired math operations. At this Step 302,the user will hear an IVR with various math operations options to select from and in conjunction with selecting math operations, the system will also evaluate the criteria associated with the user to determine which math operations may be available to the user. Lower grades and level math students may or may not access all math operations and skills. Conversely, the higher grade levels or skill levels will have the entire set of math operations available to them (or some subset thereof) per their grade level determined by various institutions and factors not limited to any particular profile. A user's profile may be modified by other individuals (e.g., parents, guardians, teachers, administrators) at any time via a user portal interface provided by the system.

At IVR Level 3 (Step 303), the user is directed to select their desired difficulty level. Difficulty levels are described above in the description of the system. At this step, the system may limit the difficulty level accessible to the user based on one or more criteria (e.g., previous performance, age, grade level). One of ordinary skill in the art would appreciate that there are numerous criteria that may be utilized with embodiments of the present invention, and embodiments of the present invention are contemplated for use with any criteria.

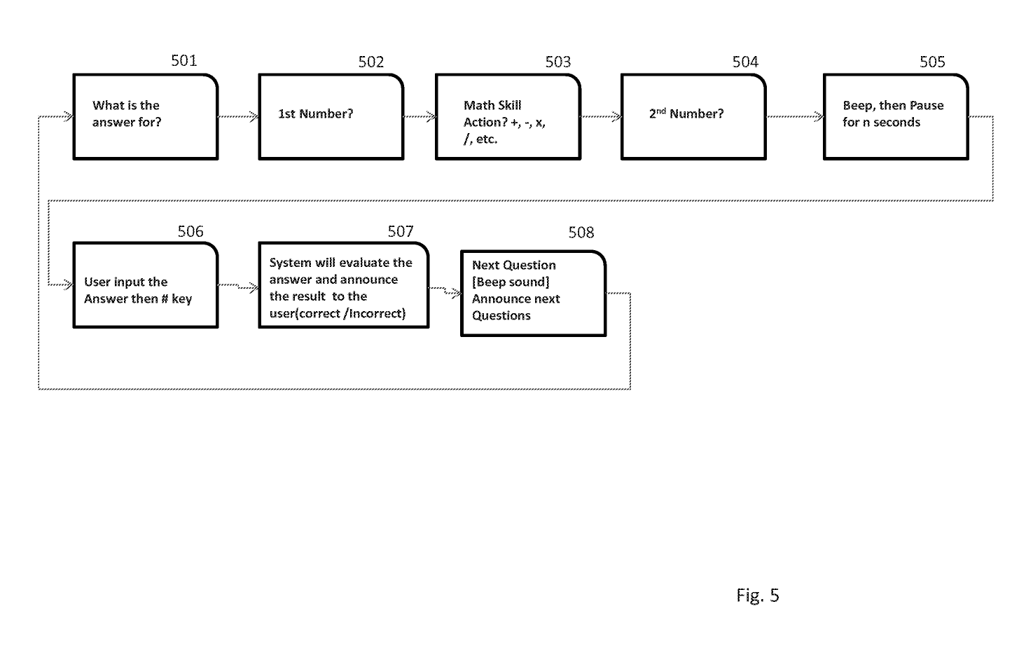

Turning now to FIG. 5, an exemplary process for IVR Levels 4-5 (Steps 304-305) is shown. As to the process shown in FIG. 5, first, the system is configured to present a question to the user based on the steps 501-505. First, the system announces the preamble to the question 501, the system then presents a first number 502. The first number (and all numbers utilized in Step 304) may be generated or received in numerous manners. For instance, a number may be created by a random number generator, retrieved from a data store communicatively connected to the system or any combination thereof. One of ordinary skill in the art would appreciate that there are numerous manners in which a number could be generated or received, and embodiments of the present invention are contemplated for use with any method for generating or receiving numbers. In other embodiments, questions and answers may be hardcoded or otherwise stored in one or more data stores (e.g., in a database server) and retrieved by processing components of the system upon request. One of ordinary skill in the art would appreciate that there are numerous methods for storing and retrieving questions from one or more data stores or hardcoded means, and embodiments of the present invention are contemplated for use with any means and methods for retrieving and processing questions. At step 503, the system announces the mathematical operation to be used (e.g., multiplication, division, subtraction, addition). At step 504, the system announces a second number. At step 505, the system generates an audible tone or other notification to the user. The tone is used to notify the user that the system is ready to receive a response to the question posed by the sum of steps 501-504. The system then waits a specified amount of time for a response. The time for response may be based on one or more factors, including the complexity of the question, the type of question, the number of digits in numbers 1 and 2, the number of digits in the answer or any combination thereof. One of ordinary skill in the art would appreciate that there are numerous methods for determining an appropriate delay for response, and embodiments of the present invention are contemplated for use with any method for determining an appropriate delay for response. Further, while the example is based on an operation involving two numbers and a single operator, embodiments of the present invention may utilize any amount of numbers and operators.

At step 506, the user enters an answer via one or more of the methods described above with respect to the entrance of responses. The termination of the entrance of a response may be effected by the selection of a special character (e.g., # key) or by making a verbal statement associated with the termination of the entrance of a response (e.g., user says “end response”).

At step 507, the system evaluates the given response and announces the result to the user. If the answer is incorrect, the system may be further configured to provide the correct answer and/or instructions for how to arrive at the correct answer.

At step 508, the system repeats the process for the number of questions desired. Default or increased numbers of questions are announced to User (e.g., as provided for in optional step 304a). Parents may select, such as through the optional step proposed in step 304a, to increase the number of questions for as high as he/she believes User is able to challenge the quiz sessions. This selection may be made prior to or during a quiz session. In a preferred embodiment of the present invention, the system may be configured to record the number of incorrect answer and correct answers given by the user and calculate scores and statistics with regards to those answers. For instance, the system may calculate that the user did well on multiplication of numbers of base 2, but poor on multiplication of numbers of base 3. In this manner, the system can provide targeted results to help parents, instructors or other individuals focus on areas that a particular user needs to improve upon.

While the diagrams and methods described above utilize 6 IVR levels, one of ordinary skill in the art would appreciate that these steps and IVR levels could be utilized in numerous manners and provided with more or less IVR levels and still achieve the methods accomplished herein. One of ordinary skill in the art would appreciate that embodiments of the present invention could be utilized with any number of IVR levels, and embodiments of the present invention are contemplated for use with any number of IVR levels.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A method for providing telephony based mathematic testing, the method comprising the steps of:
receiving a communication from a user over a telephony means;
verifying said user via an audio based authentication means;
receiving a selection of academic subject to be tested from said user;
providing to said user one or more questions in an audio format, wherein said one or more questions are selected from said academic subject;
receiving an answer from said user over said telephony means;
checking said answer for correctness; and
providing a response to said user based on said answer.

2. The method of claim 1, wherein each question of said one or more questions is comprised of a preamble, a first number, an operator and a second number.

3. The method of claim 2, wherein said preamble and said operator are retrieved from a database and said first number and said second number are generated by a random number generator.

4. The method of claim 3, wherein audio for said preamble, said operator, said first number and said second number are generated by a text-to-speech generator.

5. The method of claim 1, wherein said answer is retrieved from a database associated with said one or more questions.

6. The method of claim 4, wherein said answer is generated automatically by a computing device applying said operator to said first number and said second number.

7. The method of claim 1, further comprising the steps of:
providing an audible option for altering an amount of questions comprising said one or more questions;
receiving an audible response to said audible option; and
altering said amount of questions based on said audible response.

8. The method of claim 1, wherein each question of said one or more questions is comprised of a preamble, one or more numbers and one or more operators.

9. A system for providing telephony based mathematic testing, the system comprising:
a telephony based interactive voice response module comprising computer-executable code stored in non-volatile memory;
a processor; and
a telephony means,
wherein said interactive voice response module, said processor, and said telephony means are operably connected and are configured to:
receive a communication from a user over a telephony means;
verifying said user via an audio based authentication means;
receiving a selection of academic subject to be tested from said user;
providing to said user one or more questions in an audio format, wherein said one or more questions are selected from said academic subject;
receiving an answer from said user over said telephony means;
checking said answer for correctness; and
providing a response to said user based on said answer.

10. The system of claim 9, wherein said each question of said one or more questions is comprised of a preamble, a first number, an operator and a second number.

11. The system of claim 10, wherein said preamble and said operator are retrieved from a database and said first number and said second number are generated by a random number generator.

12. The system of claim 11, wherein audio for said preamble, said operator, said first number and said second number are generated by a text-to-speech generator.

13. The system of claim 9, wherein said answer is retrieved from a database associated with said one or more questions.

14. The system of claim 12, wherein said answer is generated automatically by a computing device applying said operator to said first number and said second number.

15. The system of claim 9, wherein said interactive voice response module, said processor, and said telephony means are further configured to:
provide an audible option for altering an amount of questions comprising said one or more questions;
receive an audible response to said audible option; and
alter said amount of questions based on said audible response.

16. The system of claim 9, wherein each question of said one or more questions is comprised of a preamble, one or more numbers and one or more operators.
